(19) United States
(12) Patent Application Publication
(10) Pub. No.: US 2018/0335842 A1
(43) Pub. Date: Nov. 22, 2018

(54) HAPTIC FEEDBACK GLOVE

(71) Applicant: AxonVR Corporation, Seattle, WA (US)

(72) Inventors: Jacob A. Rubin, Seattle, WA (US); Robert S. Crockett, San Luis Obispo, CA (US); Marc Y. Goupil, San Luis Obispo, CA (US); Jeffrey D. D'Amelio, San Luis Obispo, CA (US); Bodin L. Rojanachaichanin, San Luis Obispo, CA (US); Kurt C. Sjoberg, San Luis Obispo, CA (US); Paul Piller, San Luis Obispo, CA (US); Nicholas J. Bonafede, JR., San Diego, CA (US)

(21) Appl. No.: 15/599,471

(22) Filed: May 19, 2017

(51) Int. Cl. G06F 3/01; G06F 3/023

(52) U.S. Cl. CPC G06F 3/014; G06F 3/0233; G06F 3/016

(57) ABSTRACT

A human-computer interface system including: a sensor configured to transduce the location of a finger of a hand of a user; an exoskeleton configured to exchange mechanical energy with the finger; and an interface garment, including: an interface laminate coupled to a counterpressure assembly, configured to stimulate the user by applying a pressure to the finger; a first plurality of tactile actuators configured to apply a pressure to a finger of the user; and a second plurality of tactile actuators configured to apply a pressure to a palm of the hand of the user.

This application relates to U.S. patent application Ser. No. 15/372,362 entitled WHOLE-BODY HUMAN-COMPUTER INTERFACE, filed Dec. 7, 2016, which is a continuation of U.S. patent application Ser. No. 14/981,414, filed Dec. 28, 2015, which is a continuation of International Application No. PCT/US14/44735, filed Jun. 27, 2014, which claims the benefit of Provisional Application No. 61/843,317, filed Jul. 5, 2013, all of which are incorporated in their entirety herein by reference.

### BACKGROUND OF THE INVENTION

### 1. Field of the Invention

The present invention relates generally to human-machine interfaces to the hand, and more specifically to virtual reality human-machine interfaces to the hand. Even more specifically, the present invention relates to virtual reality human-machine interfaces to the hand that include cutaneous and kinesthetic feedback.

### 2. Discussion of the Related Art

Design of immersive virtual reality human-machine interfaces to the hand is a long-standing challenge. The dexterity, sensitivity, and small size of the human hand make it extremely difficult to design a virtual reality human-computer interface that permits natural hand interaction with computer-mediated environments.

U.S. patent application Ser. No. 15/372,362 describes a whole-body human-computer interface capable of simulating highly realistic interaction with virtual reality environments. The present invention comprises a series of improvements to the hand portion of the human-computer interface garment disclosed therein. Said hand portion will hereafter be referred to as a “haptic feedback glove.”

Haptic feedback gloves have broad commercial applications, including in entertainment; medical and industrial training; and computer-aided design and manufacturing. Said applications broadly require haptic feedback gloves with the following combination of features absent in the present art:

Generality: human-machine interfaces to the hand of the present art, including haptic feedback gloves, are typically built and programmed for a single narrow range of applications. These systems employ simplified simulation parameters to achieve a design that is conducive to their particular application, but severely limited in general applicability. Such a design methodology reduces mechanical and computational complexity for some tasks, but at the cost of compromising flexibility, adaptability, and economy of scale of the resultant systems.

Realism: touch sensation is comprised of multiple sensory modalities described in the art. In particular, cutaneous feedback (mechanical stimulation of the skin), and kinesthetic feedback (net forces applied to the musculoskeletal system) are both critical for realistic touch sensation and natural interaction. Haptic feedback gloves of the present art typically only include a single sensory modality. Said devices of the present art also typically lack the resolution, displacement, frequency response, force output, or other performance characteristics required to realistically stimulate a particular sensory modality.

Practicality: to be commercially useful, haptic feedback gloves must be light and low-profile enough to be comfortably worn on the hand, and robust enough to survive repeated use in a real-world environment. They must also be low-cost enough to be commercially practical. Lastly, they must be able to be donned and doffed relatively quickly by a user. Haptic feedback gloves of the present art lack some or all of these qualities. Even the best performing devices of the known art (and in fact particularly the best performing devices) are simply impractical, as well as being substantially uneconomical. Even if these devices did overcome all of the shortcomings listed above, they would still likely be incapable of broad application due to their prohibitive cost and complexity.

Thus, there remains a significant need for an improved haptic feedback glove.

### SUMMARY OF THE INVENTION

In accordance with one embodiment, the present invention can be characterized as a human-computer interface system including: a sensor configured to transduce the location of a finger of a hand of a user; an exoskeleton configured to exchange mechanical energy with the finger; an interface garment, including: an interface laminate coupled to a counterpressure assembly, configured to stimulate the user by applying a pressure to the finger; a first plurality of tactile actuators configured to apply a pressure to a finger of the user; and a second plurality of tactile actuators configured to apply a pressure to a palm of the hand of the user.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1A is a top view of a haptic feedback glove in accordance with one embodiment of the present invention.

FIG. 1B is a bottom view of the haptic feedback glove of the embodiment of FIG. 1A.

FIG. 2 is an exploded perspective view of a fingertip assembly of the haptic feedback glove of the embodiment of FIG. 1A.

FIG. 3 is an exploded perspective view of an actuator interacting with a force transmission element of the haptic feedback glove of the embodiment of FIG. 1A.

FIG. 4 is an exploded view of a hypothenar assembly of a haptic feedback glove in accordance with one embodiment.

FIG. 5 is a partial bottom view of a thenar assembly of a haptic feedback glove, in accordance with one embodiment, showing an interface laminate, and an armature and tensile members of a counterpressure assembly.

FIG. 6 is a partial bottom view of a hypothenar assembly of a haptic feedback glove, in accordance with one embodiment, showing an interface laminate, and an armature and tensile members of a counterpressure assembly.

FIG. 7 is a partial bottom view of an interdigital assembly of a haptic feedback glove, in accordance with one embodiment, showing an interface laminate, and an armature and tensile members of a counterpressure assembly.

FIG. 8 is a block diagram of a haptic feedback glove in accordance with one embodiment.

Certain components in the figures that are substantially identical across each finger (e.g. 135, 133, 202, 261, 252, 250, 254, 258, 260, 262, 206, 132, 207, 204, 205, 208, 118, 119, 120, 121, 122, 123, 124, 125, 146, 142, 143, 140, 148, 315, 316, 314, 202, 320, 308, 310, 324, 326, 306, 304, 207) are given only a single label for clarity. References through the Detailed Description to these components should be understood to apply to said components of any or all fingers.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment, “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are presented to provide a thorough understanding of embodiments of the invention. One skilled in the relevant art will recognize that the invention can be practiced without one or more of the specific details, or with other methods, components, materials, and so forth. In other instances, well-known structures, materials, or operations are not shown or not described in detail to avoid obscuring aspects of the invention.

### Definitions and Conventions

Definitions and conventions are identical to those in U.S. patent application Ser. No. 15/372,362, unless otherwise specified.

As used herein, the term “haptic feedback glove” means: a hand portion of a human-computer interface garment.

As used herein, the term “finger” means: a digit of the hand, including the thumb. “Digit” and “finger” are used interchangeably throughout the present application.

As used herein, the term “mechanical ground” means: a point that is substantially fixed and immovable with respect to a finger of the user, rather than with respect to the user as a whole as defined in U.S. patent application Ser. No. 15/372,362.

As used herein, the term “position sensor” means: a sensor configured to detect at least one of position and orientation.

As used herein, the term “force sensor” means: a sensor configured to detect at least one of force and torque.

### Overview

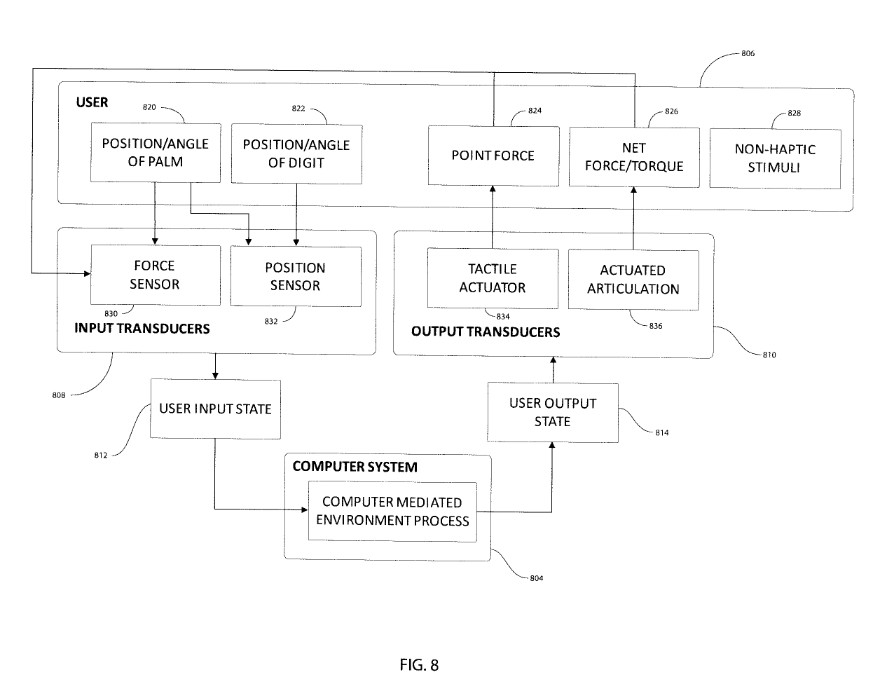

FIG. 8 shows a block diagram of a haptic feedback glove in accordance with one embodiment of the present invention. Shown is a plurality of input transducers 808 and output transducers 810 coupled to a computer system 804 and to a user 806. The input transducers 808 receive input from the user 806, and transduce that input to a user input state 812 preferably defined at a discrete time step n. The output transducers 810 receive a user output state 814 from the computer system 804, preferably defined at a discrete time step n+1. The user output state 814 is transduced by the output transducers 810 to an appropriate form so as to stimulate one or more of the user's 806 sensory systems. Non-haptic stimuli 828 (e.g. visual, auditory, or chemosensory stimuli) are preferably synchronized with haptic stimuli provided by the haptic feedback glove as described in U.S. patent application Ser. No. 15/372,362.

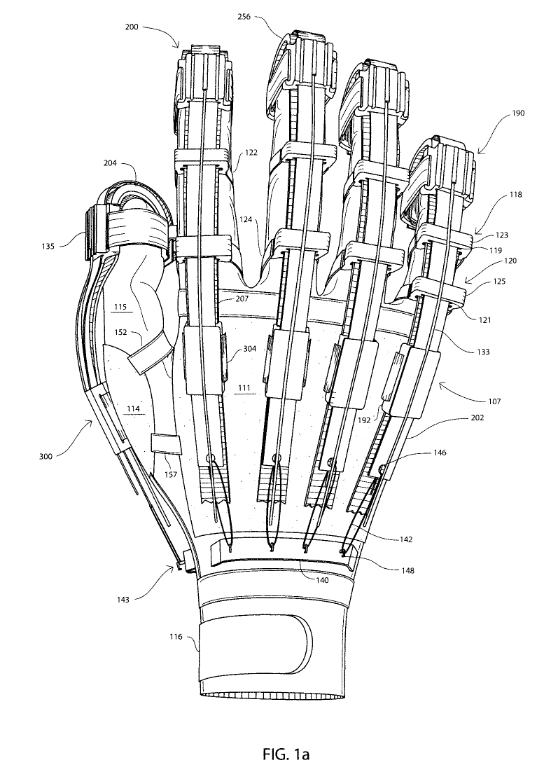

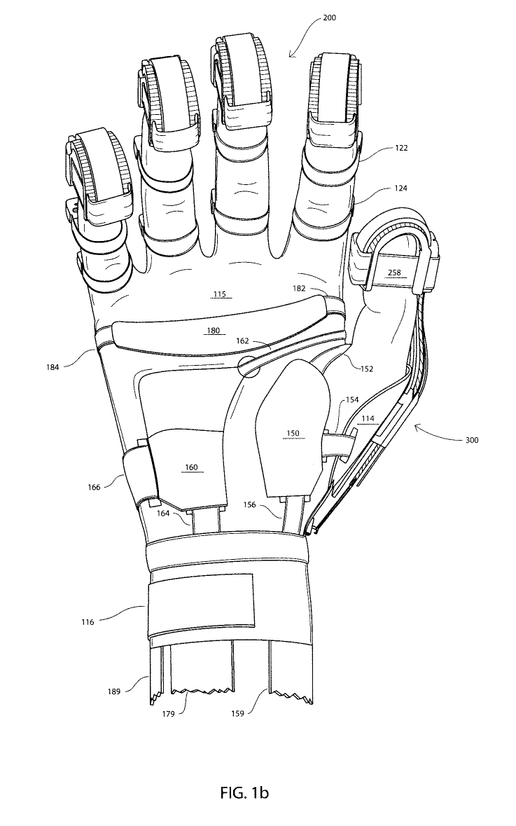

FIGS. 1A and 1B show a top and bottom view respectively of a haptic feedback glove in accordance with one embodiment of the present invention. The haptic feedback glove comprises an interface garment, including an interface laminate and an exoskeleton. Position sensors transduce the position of the user's digits. Preferably, an additional position sensor transduces the position of the user's palm.

### Interface Laminate

In a preferred embodiment, a haptic feedback glove comprises an interface laminate comprising a plurality of tactile actuators 834 (FIG. 8) coupled to the skin of the user's hand. A counterpressure assembly provides a normal force counter to the force produced by said interface laminate against the user's skin, holding the interface laminate against the skin during actuation of tactile actuators of the laminate and motion of the user's hand.

### Fingertip Assembly

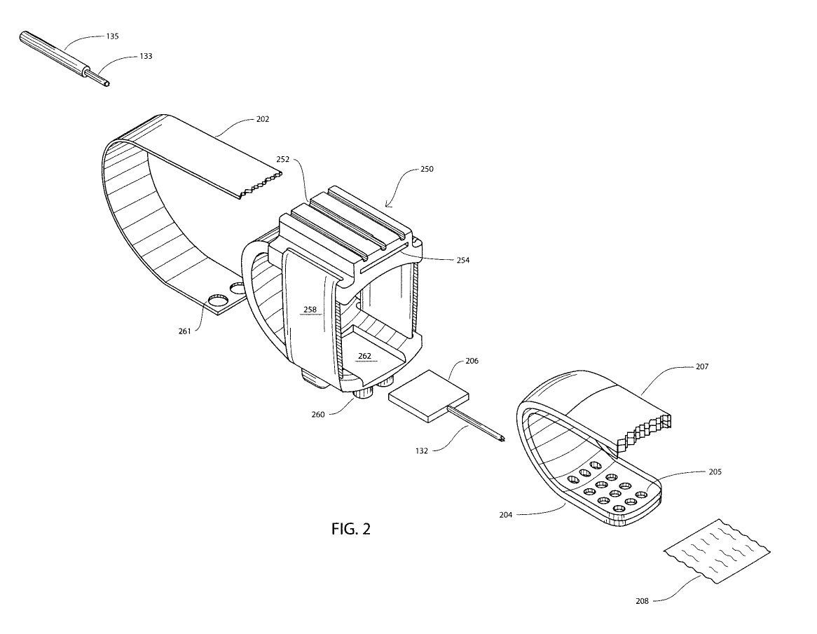

Referring to FIG. 2, a fingertip assembly 200 of a haptic feedback glove preferably comprises an interface laminate segment 204 located such that tactile actuators 205 are coupled to substantially all of the user's finger pad. In a preferred embodiment, fingertip assembly 200 comprises at least 12 tactile actuators 205 contacting said finger pad. In a more preferred embodiment, fingertip assembly 200 comprises at least 24 tactile actuators contacting said finger pad. In a preferred embodiment, tactile actuators 205 of fingertip assembly 200 are configured to produce a displacement of at least 0.5 mm. In a more preferred embodiment, tactile actuators 205 of fingertip assembly 200 are configured to produce a displacement of at least 1 mm.

The interior surface of interface laminate segment 204 is coupled to intermediate layer 208. Intermediate layer 208 is in turn coupled to the user's hand. The exterior surface of interface laminate segment 204 is coupled to the interior surface of fingertip counterpressure assembly 250. Ribbon assembly 207 of interface laminate segment 204 preferably exits the proximal side of fingertip counterpressure assembly 250, above the user's nail.

Fingertip counterpressure assembly 250 comprises an armature 256 and a tensile member 258. Armature 256 provides structural support to fingertip assembly 200, helping interface laminate segment 204 remain in continuous contact with the user's finger. Armature 256 is coupled to interface laminate segment 204 by means of a suitable adhesive, preferably room-temperature vulcanization silicone. In one embodiment, armature 256 comprises an elastomer, such as polydimethylsiloxane or fiberglass-reinforced silicone. In another embodiment, armature 256 comprises a non-elastomeric polymer, such as high-density polyethylene or polyimide.

Armature 256 is coupled to tensile member 258, which resists forces applied orthogonal to the interior surface of armature 256 by interface laminate segment 204. Tensile member 258 preferably comprises an elastic textile, such as Lycra, an elastomer, such as latex, or another suitable high strain material. Tensile member 258 serves a secondary purpose as a donning aid, enabling fingertip assembly 200 to stretch to accommodate various finger sizes, while retaining a suitable level of counterpressure for the operation of interface laminate segment 204. Sensor mounting point 252 is a declivity in the upper surface of armature 256 that provides a mounting point for magnetic position sensor 135, and aids in the routing of position sensor leads 133.

Armature 256 is preferably shaped such that it closely matches the curvature of the user's fingertip. In one embodiment, fingertip armature 256 is slightly undersized relative to the distal phalange of the target user, such that it produces a nominal force against the top and bottom of the finger when worn to help interface laminate segment 204 remain in contact with the fingertip. In a preferred embodiment, Armature 256 does not extend to the medial and lateral sides of the finger to avoid interfering with finger ad- and abduction. Similarly, the bottom proximal portion of armature 256 ends distally enough to the distal interphalangeal crease to avoid interfering with the motion of the distal interphalangeal joint.

Embodiments are contemplated in which tactile interface laminate segments are also coupled to the pads of the intermediate and proximal phalanges of one or more of the user's fingers, in addition to the pad of the distal phalange. Embodiments are also contemplated in which tactile interface laminate segments extend to the dorsal, medial, or lateral aspects of the fingers. One or more separate segments may also be employed to extend sensation to the dorsal, medial, or lateral aspects of the fingers, rather than extending the existing segments.

Fingertip assembly 200 is coupled to fabric substrate 115 to facilitate ease of donning. Fabric substrate 115 preferably comprises Lycra or another lightweight, elastic fabric. While alternate embodiments are contemplated in which fingertip assemblies are donned as separate elements, in the preferred embodiment, fingertip assemblies are all coupled to fabric substrate 115 such that they can be donned with a single motion, like a typical glove.

Interface laminate segment 204 is coupled to a vibration actuator 206. In a preferred embodiment, vibration actuator 206 is configured to produce vibrations of 20 Hz-300 Hz that are detectible by the user through interface laminate segment 204 and intermediate layer 208. In a more preferred embodiment, vibration actuator 206 is configured to produce vibrations of 20 Hz-1 kHz that are detectible by the user through interface laminate segment 204.

Vibration actuator 206 preferably comprises a multi-layer piezoelectric actuator, such as a piezoceramic or piezopolymer actuator, a non-piezoelectric electroactive polymer actuator, or another suitable solid state actuator. In a first alternate embodiment, vibration actuator 206 comprises an electromechanical actuator, such as an eccentric rotating mass, linear resonant actuator, or other vibration motor. In a second alternate embodiment, vibration actuator 206 comprises a fluidic actuator.

A portion of vibration actuator 206 is coupled to inner surface 262 of fingertip armature 256, such that a majority of vibration actuator 206 is still permitted free motion relative to inner surface 262. An air gap is preferably left between the inner surface of vibration actuator 206 and the outer surface of interface laminate segment 204. In an alternate embodiment, vibration actuator 206 is placed on the top, rather than the bottom, portion of fingertip armature 256, such that it contacts the user's fingernail. In this embodiment, vibrations are transmitted through the fingernail and distal phalange into the finger pulp.

Vibration actuator 206 is coupled to vibration actuator leads 132, which supply electric power to vibration actuator 206. Vibration actuator leads 132 preferably run along the back of the user's finger, as shown in FIG. 1A, in accordance with one embodiment.

### Palm Assembly

Referring to FIG. 1B, a palm portion of a haptic feedback glove comprises a plurality of palm assemblies—thenar assembly 150, hypothenar assembly 160, and interdigital assembly 180—configured to permit uninhibited movement of the user's hand while remaining in contact with as much of the user's palm as possible. Thenar assembly 150 contacts the thenar eminence of the user's palm. Hypothenar assembly 160 contacts the hypothenar eminence of the user's palm. Interdigital assembly 180 sits between the transverse creases (distal and proximal) of the user's palm and the palmar interdigital creases of the user's fingers, in the interdigital region of the palm. The thenar crease and distal and proximal transverse creases are left deliberately free of material to maximize hand mobility. Alternate embodiments of a haptic feedback glove are contemplated wherein more or less than three palm assemblies are employed.

### Hypothenar Assembly

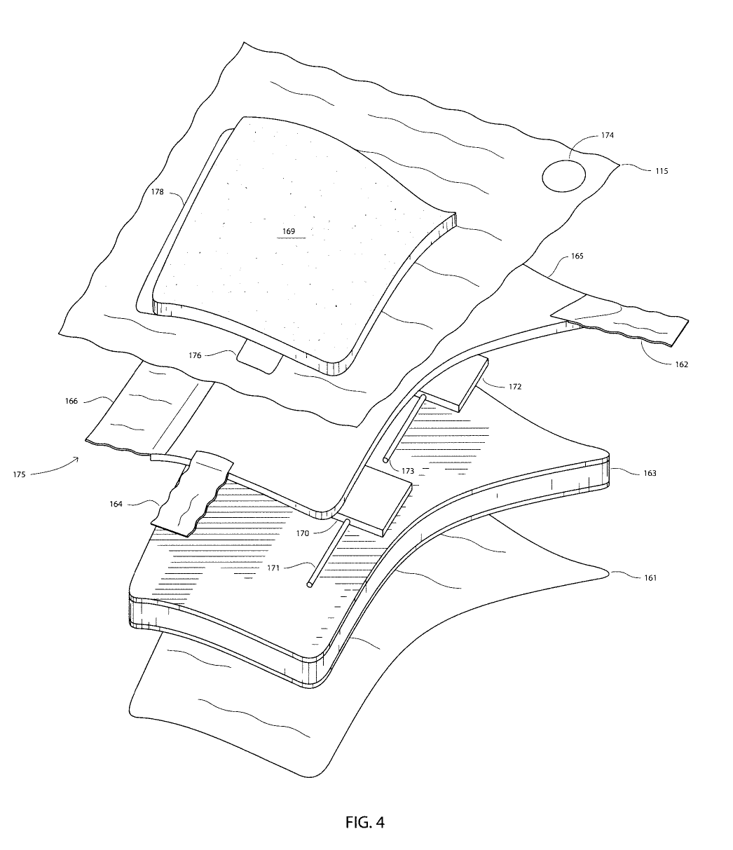

FIG. 4 shows an exploded view of hypothenar assembly 160, in accordance with one embodiment. Hypothenar assembly 160 comprises interface laminate segment 163, coupled to the skin of the user's hypothenar eminence by means of intermediate layer 161. In a preferred embodiment, interface laminate segment 163 comprises a tactile actuator density of at least 0.75 actuators per square centimeter. In a more preferred embodiment, interface laminate segment 163 comprises a tactile actuator density of at least 1.50 actuators per square centimeter. In a preferred embodiment, tactile actuators of interface laminate segment 163 are configured to produce a displacement of at least 1 mm. In a more preferred embodiment, tactile actuators of interface laminate segment 163 are configured to produce a displacement of at least 2 mm.

The bottom surface of interface laminate segment 163 is coupled to intermediate layer 161. Intermediate layer 161 is in turn coupled to the user's hand. The top surface of interface laminate segment 163 is coupled to the bottom surface of hypothenar counterpressure assembly 175. Ribbon assembly 179 of interface laminate segment 163 preferably exits the proximal side of hypothenar counterpressure assembly 175, being routed through wrist strap 116.

Hypothenar counterpressure assembly 175 comprises an armature 165 and a plurality of tensile members 162, 164, 166. Armature 165 provides structural support to hypothenar assembly 160, helping interface laminate segment 163 remain in continuous contact with the user's hypothenar eminence. Armature 165 is coupled to interface laminate segment 163 by means of a suitable adhesive, preferably room-temperature vulcanization silicone 169. In one embodiment, armature 165 comprises an elastomer, such as polydimethylsiloxane or fiberglass-reinforced silicone. In another embodiment, armature 165 comprises a non-elastomeric polymer, such as high-density polyethylene or polyimide.

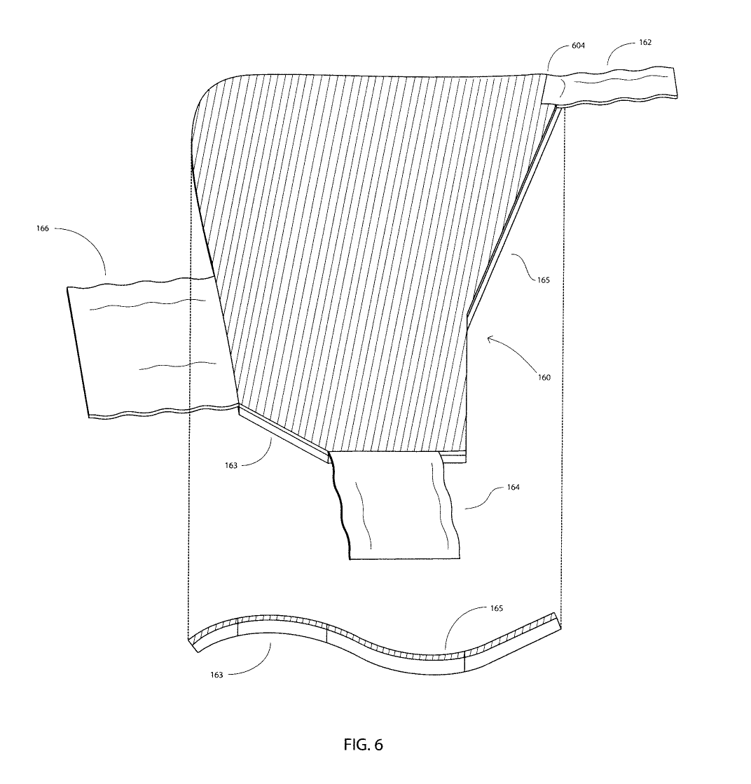

FIG. 6 shows the geometry of hypothenar assembly 160 in a top and side view respectively, in accordance with one embodiment. Hypothenar assembly 160 is generally shaped to match the shape and curvature of the user's hypothenar eminence. Distolateral tip 604 of hypothenar assembly 160 is preferably flared slightly above the surface of the palm to aid in the generation of a counterforce against the portion of the user's palm under said tip.

Referring now to FIGS. 1A and 1B, armature 165 is coupled to tensile members 162, 164, 166 which resist forces applied orthogonal to the interior surface of armature 165 by interface laminate segment 163. Tensile members 162, 164, 166 preferably comprise an elastic textile, such as Lycra. Said tensile members 162, 164, 166 can also comprise an elastomer, such as latex, or another suitable high strain material. Tensile members 162, 164, 166 serve a secondary purpose as a donning aid, enabling hypothenar assembly 160 to stretch to accommodate various hand sizes, while retaining a suitable level of counterpressure for the operation of interface laminate segment 163.

Tensile member 162 is routed through a cutout 174 in fabric substrate 115, over the top of the user's thenar eminence, through the thenar space, and is coupled to opisthenar plate 111 located on the back of the user's hand. Opisthenar plate 111 comprises any suitable rigid structural material, preferably a polymer or fiber-reinforced polymer composite. Tensile member 166 is routed through a cutout 178 in fabric substrate 115, medially over the blade of the palm to couple to the medial side of opisthenar plate 111. Tensile member 164 is routed proximally through a cutout 176 in fabric substrate 115 and coupled to wrist strap 116, which substantially encircles the user's wrist.

Interface laminate segment 163 is coupled to vibration actuator assemblies 170, 172. Vibration actuator assemblies 170, 172 comprise a casing and a vibration actuator. In a preferred embodiment, said vibration actuators are configured to produce vibrations of 20 Hz-300 Hz that are detectible by the user through interface laminate segment 163 and intermediate layer 161. In a more preferred embodiment, said vibration actuators are configured to produce vibrations of 20 Hz-1 kHz that are detectible by the user through interface laminate segment 163 and intermediate layer 161.

Vibration actuators of vibration actuator assemblies 170, 172 preferably comprise a multi-layer piezoelectric actuator, such as a piezoceramic or piezopolymer actuator, a non-piezoelectric electroactive polymer actuator, or another suitable solid state actuator. In an alternate embodiment, said vibration actuators comprise an electromechanical actuator, such as an eccentric rotating mass, linear resonant actuator, or other vibration motor.

A portion of the vibration actuators of vibration actuator assemblies 170, 172 is coupled to the upper inner surface of their casings, such that a majority of said vibration actuators are still permitted free motion relative to said upper inner surfaces. An air gap is preferably left between the bottom surface of the vibration actuators and the top surface of interface laminate segment 163.

Vibration actuator assemblies 170, 172 are preferably spaced substantially evenly across the surface area of the user's hypothenar eminence, with a density of least 0.1 actuators per square centimeter. In a more preferred embodiment, vibration actuators have a density of least 0.2 actuators per square centimeter. Vibration actuators of vibration actuator assemblies 170, 172 are coupled to vibration actuator leads 171, 173 which supply electric power to the vibration actuators of said assemblies. Vibration actuator leads 171, 173 preferably run along the user's palm to the wrist.

Embodiments are contemplated in which tactile interface laminate segments extend to the dorsal or medial aspects of the hypothenar eminence. One or more separate segments may also be employed to extend sensation to dorsal or medial aspects of the hypothenar eminence, rather than extending the existing segments. As with fingertip assembly 200, hypothenar assembly 160 is coupled to fabric substrate 115 to facilitate ease of donning.

### Thenar Assembly

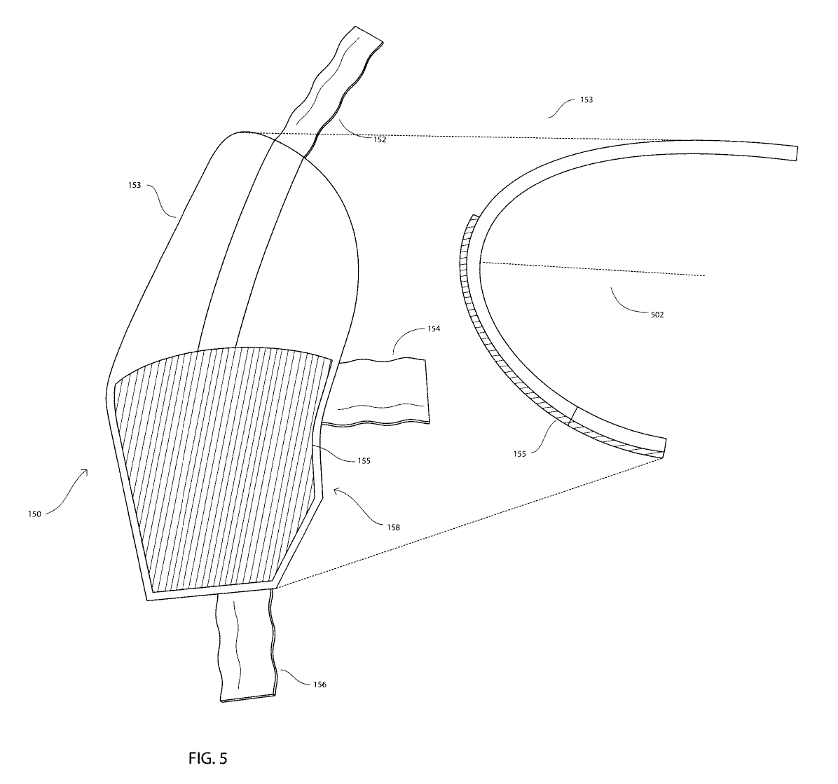

Referring now to FIGS. 1B and 5, thenar assembly 150 comprises interface laminate segment 153, coupled to the skin of the user's thenar eminence by means of an intermediate layer (not shown). Tactile actuator density and displacement of interface laminate segment 153 are similar to interface laminate segment 163 of hypothenar assembly 160. Tactile actuator displacement and density can vary between palm assemblies. For instance, the tactile actuator density of interface laminate segment 153 can be slightly higher than that of interface laminate segment 163 due to increased tactile sensitivity in the thenar region.

The bottom surface of interface laminate segment 153 is coupled to an intermediate layer (not shown), which is in turn coupled to the user's hand. The top surface of interface laminate segment 153 is coupled to the bottom surface of thenar counterpressure assembly 158. Ribbon assembly 159 of interface laminate segment 153 preferably exits the proximal side of thenar counterpressure assembly 158, being routed proximally through wrist strap 116.

As with hypothenar counterpressure assembly 175, thenar counterpressure assembly 158 comprises an armature 155 and a plurality of tensile members 152, 154, 156 of substantially identical composition to those of hypothenar counterpressure assembly 175. FIG. 5 shows the geometry of thenar assembly 150 in a top and projected view respectively, in accordance with one embodiment. Thenar assembly 150 is generally shaped to match the shape and curvature of the user's thenar eminence. Radius of curvature 502 is preferably slightly smaller than the corresponding radius of curvature of the user's thenar eminence. Said difference in radius of curvature provides a nominal force against the user's thenar eminence when thenar assembly 150 is worn to help interface laminate segment 153 remain in contact with the thenar eminence.

In a preferred embodiment, the stiffness of thenar assembly 150 varies across its surface. Said variation in stiffness minimizes interference with thenar motion, particularly around the thenar crease and palmar interdigital crease of the thumb, while maintaining sufficient structural integrity to provide effective counterpressure for interface laminate segment 153. The portion of thenar assembly 150 bonded to armature 155 has a higher stiffness than remaining portions comprising only the interface laminate. Armature 155 does not extend all the way to the thenar crease and palmar interdigital crease of the thumb, creating a more compliant region in thenar assembly 150 around these highly mobile areas.

Referring now to FIGS. 1A and 1B, armature 155 is coupled to tensile members 152, 154, 156 which resist forces applied orthogonal to the interior surface of armature 155 by interface laminate segment 153. Tensile members 152, 154, 156 are of substantially identical composition and purpose to those of hypothenar assembly 160.

Tensile member 152 is routed over the top of the user's thenar eminence, through the thenar space, and is coupled to thenar plate 114 located on the dorsum of the user's thumb. Thenar plate 114 comprises any suitable rigid structural material, preferably a polymer or fiber-reinforced polymer composite. Tensile member 154 is coupled to thenar plate 114 above the first metacarpal. Thenar plate 114 is preferably coupled to opisthenar plate 111 by means of tensile member 157. Tensile member 156 is routed proximally through wrist strap 116.

Thenar assembly 150 comprises vibration actuators substantially identical to those of hypothenar assembly 160. Said thenar vibration actuators are preferably spaced substantially evenly across the surface area of the user's thenar eminence, with a density similar to the vibration actuators of the hypothenar assembly 160.

Embodiments are contemplated in which tactile interface laminate segments extend to the dorsal, lateral, or proximal aspects of the thenar eminence. One or more separate segments may also be employed to extend sensation to dorsal, lateral, or proximal aspects of the thenar eminence, rather than extending the existing segments. As with fingertip assembly 200, and hypothenar assembly 160, thenar assembly 150 is coupled to fabric substrate 115 to facilitate ease of donning.

### Interdigital Assembly

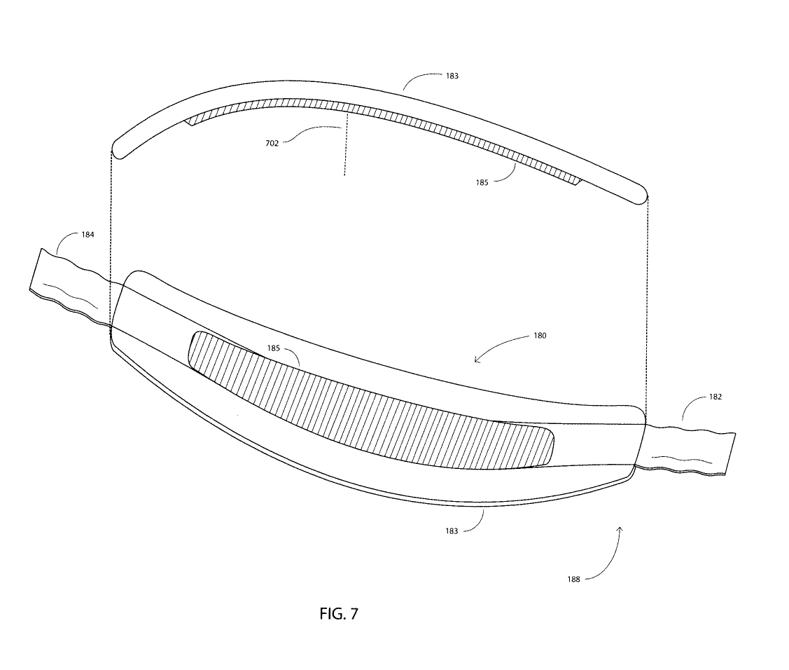

Referring now to FIGS. 1B and 7, interdigital assembly 180 comprises interface laminate segment 183, coupled to the skin of the interdigital region of the user's palm by means of an intermediate layer (not shown). Tactile actuator density and displacement of interface laminate segment 183 are similar to interface laminate segment 163 of hypothenar assembly 160. Tactile actuator displacement and density can vary between palm assemblies. For instance, the tactile actuator displacement of interface laminate segment 183 can be slightly lower than that of interface laminate segment 163.

The bottom surface of interface laminate segment 183 is coupled to an intermediate layer (not shown), which is in turn coupled to the user's hand. The top surface of interface laminate segment 183 is coupled to the bottom surface of interdigital counterpressure assembly 188. Ribbon assembly 189 of interface laminate segment 183 preferably exits the medial side of interdigital counterpressure assembly 188, being routed around the fifth metacarpal to the dorsal aspect of the hand, then along the back of the hand to the wrist.

As with hypothenar counterpressure assembly 175, and thenar counterpressure assembly 158, interdigital counterpressure assembly 188 comprises an armature 185 and a plurality of tensile members 182, 184 of substantially identical composition to said other palm assemblies. FIG. 7 shows the geometry of interdigital assembly 180 in a top and projected view respectively, in accordance with one embodiment. Interdigital assembly 180 is generally shaped to match the shape and curvature of the interdigital region of the user's palm. Radius of curvature 702 is preferably slightly smaller than the corresponding radius of curvature of the user's palm. Said difference in radius of curvature provides a nominal force against the user's palm when interdigital assembly 180 is worn to help interface laminate segment 183 remain in contact with the user's palm.

In a preferred embodiment, the stiffness of interdigital assembly 180 varies across its surface. Said variation in stiffness minimizes interference with the motion of the index, middle, ring, and pinky fingers, particularly around the distal and proximal transverse creases and the palmar interdigital creases of said fingers, while maintaining sufficient structural integrity to provide effective counterpressure for interface laminate segment 183. The portion of interdigital assembly 180 bonded to armature 185 has a higher stiffness than remaining portions comprising only the interface laminate. Armature 185 does not extend all the way to the distal and proximal transverse creases and the palmar interdigital creases of the index, middle, ring, and pinky fingers, creating a more compliant region in interdigital assembly 180 around these highly mobile areas.

Referring now to FIGS. 1A and 1B, armature 185 is coupled to tensile members 182, 184 which resist forces applied orthogonal to the interior surface of armature 185 by interface laminate segment 183. Tensile members 182, 184 are of substantially identical composition and purpose to those of thenar assembly 150 and hypothenar assembly 160.

Tensile member 184 is routed medially over the fifth metacarpal to couple to the medial side of opisthenar plate 111 located on the back of the user's hand. Tensile member 182 is routed laterally over the second metacarpal to couple to the lateral side of opisthenar plate 111.

Interdigital assembly 180 comprises vibration actuators substantially identical to those of thenar assembly 150, and hypothenar assembly 160. Said interdigital vibration actuators are preferably spaced substantially evenly across the surface area of the interdigital region of the user's palm, with a density similar to the vibration actuators of the thenar and hypothenar assemblies.

Embodiments are contemplated in which tactile interface laminate segments extend to the dorsal, medial, or lateral aspects of the interdigital region of the user's palm. One or more separate segments may also be employed to extend sensation to dorsal, medial, or lateral aspects of the interdigital region, rather than extending the existing segments. As with fingertip assembly 200, thenar assembly 150, and hypothenar assembly 160, interdigital assembly 180 is coupled to fabric substrate 115 to facilitate ease of donning.

### Exoskeleton

In a preferred embodiment, a haptic feedback glove comprises an exoskeleton, said exoskeleton comprising a plurality of actuated articulations 836 (FIG. 8). Referring now to FIG. 1A, an exoskeleton of a haptic feedback glove is shown, in accordance with one embodiment. Said exoskeleton comprises: a finger exoskeleton assembly 107, including an actuator assembly 300, a kinematic termination 190, a force transmission element 202, and a mechanical ground connection 304.

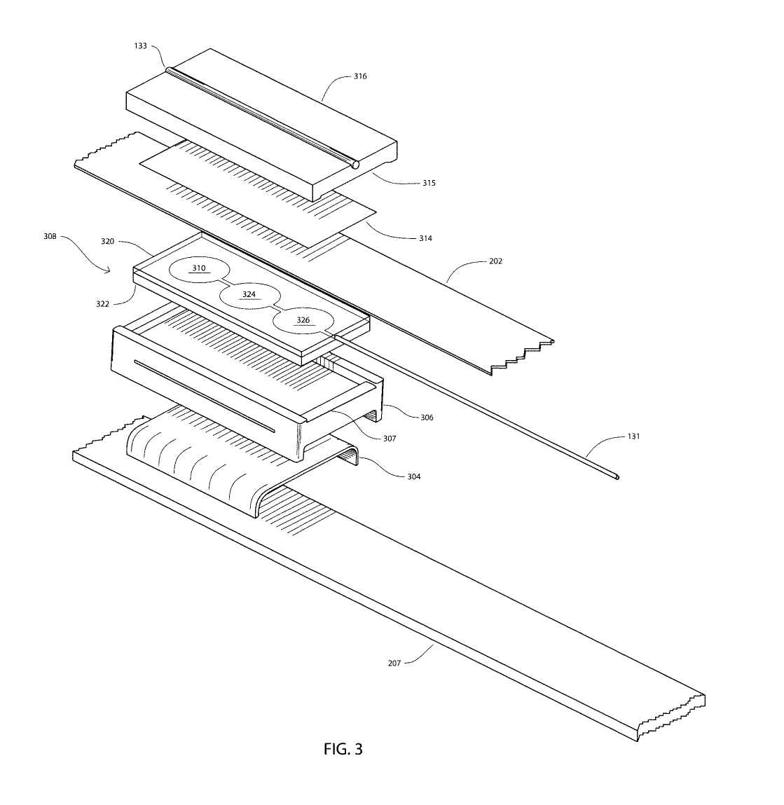

Force transmission element 202 is mechanically coupled to kinematic termination 190, and is variably coupled to mechanical ground connection 304 by means of actuator 308 (FIG. 3). Enabling actuator 308 (FIG. 3) modifies the net force on the user's finger, preferably by means of modifying the physically-defined impedance of finger exoskeleton assembly 107 by controlling the extent of mechanical coupling between force transmission element 202 and mechanical ground connection 304.

### Kinematic Termination

FIG. 2 shows an exploded perspective view of the fingertip assembly 200 of a haptic feedback glove, in accordance with one embodiment, comprising a kinematic termination 190. Kinematic termination 190 comprises a load path from a user's fingertip to force transmission element 202, comprising: intermediate layer 208; coupled to interface laminate segment 204; coupled in turn to fingertip counterpressure assembly 250; and finally, to force transmission element 202, by means of projection 260, through-hole 261, and guide slot 254.

The compliance of fingertip counterpressure assembly 250 can be tuned to optimize the balance between stiffness of kinematic termination 190 and the ability to accommodate a wide range of finger sizes. A more compliant fingertip counterpressure assembly 250 will enable fingertip assembly 200 to stretch to fit a greater range of finger sizes, while still providing effective counterpressure, at the expense of reducing the effective stiffness of the constraint to finger motion imposed by finger exoskeleton assembly 107 (FIG. 1A).

Finger motion acting against the finger exoskeleton assembly 107 results in reaction forces which are distributed via the load path of kinematic termination 190 to the user's finger. Preferably, this termination of reaction forces occurs at the distal phalange of the finger. More preferably, this termination of reaction forces is distributed approximately evenly across the palmar surface of said phalange. The kinematic termination 190 is preferably shaped to minimize interference with finger motion and interference with a wearer's workspace, particularly.

In a preferred embodiment, interface laminate segment 204 acts to distribute the net force on the user's fingertip produced by the action of finger exoskeleton assembly 107 via kinematic termination 190, such that point forces at the fingertip approximate the physical point forces resulting from a particular object interaction. For example, pressing on a simulated pin and a simulated flat surface in a virtual environment might produce identical net forces on the user's fingertip, as rendered by the action of finger exoskeleton assembly 107; however, these interactions would produce very different point forces on the skin of the fingertip as rendered by the action of tactile actuators 205 of interface laminate segment 204.

### Force Transmission Element

Referring to FIG. 1A, the action of finger exoskeleton assembly 107 results in forces which are transmitted from kinematic termination 190 to mechanical ground connection 304 via force transmission element 202. Force transmission element 202 can be designed to transmit both tensile and compressive forces (e.g. a continuous mechanical linkage), compressive forces only (e.g. a series of disconnected linkages sharing a common centerline), or tensile forces only (e.g. a cable).

In a preferred embodiment shown in FIG. 1A, force transmission element 202 is a tendon located on the dorsum of the user's hand that transmits tensile forces, applying forces to the user's finger during grasping motions involving finger flexion while allowing unhindered finger extension. Force transmission element 202 is preferably ribbon shaped (i.e. having a ratio of width to thickness of at least 10), and composed of nylon or another suitable polymer or non-polymer material with minimal elongation under tensile load, a smooth surface finish, flexibility under bending load, high toughness, and a low coefficient of friction relative to any bearing surfaces—e.g. actuator casing lower lip 307, and upper lip 315 (FIG. 3), or force transmission element guide slots 119, 121.

Numerous alternate cross-sectional geometries of a force transmission element are contemplated, including circular, elliptical, and multi-body or multi-stranded cross sections. Cross section can vary across the length of a force transmission element. For example, the portion of force transmission element 202 contacting actuator assembly 300 can be ribbon shaped to maximize contact area between the actuator assembly 300 and the force transmission element 202, while other portions of the force transmission element 202 have a circular cross section.

Force transmission element 202 is coupled to the user's finger by means of kinematic termination 190. Said force transmission element 202 is then coupled to force transmission guides 118 and 120, which are in turn coupled to the intermediate and proximal phalanges of the user's finger. Force transmission element 202 is free to slide proximodistally via force transmission element guide slots 119, 121 in force transmission guides 118, 120, but is substantially fully constrained in all other axes of motion. During flexion of the user's finger, when finger exoskeleton assembly 107 is active, force transmission element 202 applies a compressive load to structural members 123, 125, which in turn apply an equal compressive load to the top of the user's finger. The height of force transmission element guide slots 119, 121 relative to the user's finger strongly influences both the magnitude and vector of force that will be applied to the kinematic termination 190 for a given tensile force on force transmission element 202 and a given position of the user's finger. In a preferred embodiment, said height of force transmission element guide slots 119, 121 is greater than 0.5 cm and less than 5 cm. In a more preferred embodiment, said height of force transmission element guide slots 119, 121 is greater than 1 cm and less than 2.5 cm.

Elastic straps 122, 124 secure force transmission guides 118, 120 to the intermediate and proximal phalanges of the user's finger. Said elastic straps 122, 124 are preferably composed of an elastic fabric, such as Lycra, but can also be composed of an elastomer or other suitable elastic material. As with fingertip counterpressure assembly 250, elastic straps 122, 124 are preferably coupled to fabric substrate 115 to facilitate the donning of a haptic feedback glove as a single unit, in the manner of a typical glove.

In one embodiment, force transmission element 202 is coupled to a vibration actuator, of any of the types described above, located proximally to fingertip assembly 200. Vibrations from said actuator are transmitted to fingertip assembly 200 by means of force transmission element 202, particularly when under tension.

### Actuator

Referring still to FIG. 1A, force transmission element 202 is variably coupled to actuator assembly 300 by means of actuator 308, and finally to tensioning mechanism 143. FIG. 3 shows an exploded perspective view of an actuator 308 interacting with a force transmission element 202, in accordance with one embodiment. An actuator assembly 300 comprises an actuator 308. Actuator 308 is configured to produce a variable force or displacement. In the preferred embodiment of FIG. 3, actuator 308 is a miniature fluidic actuator constructed in a similar manner to a fluidic actuator of a tactile actuation laminate (as detailed in U.S. patent application Ser. No. 15/372,362).

Actuator 308 comprises an elastic membrane 320 bonded to a substrate 322 to form a plurality of actuation chambers 310, 324, 326. A pressurized fluid is supplied to actuator 308 by means of tube 131, via supply orifice 328. Elastic membrane 320 can be controllably actuated by regulating the volume or pressure of working fluid flowing into and out of actuation chambers 310, 324, 326.

Alternate embodiments are contemplated in which actuator 308 comprises a solid-state actuator (such as a piezoceramic or piezopolymer, or non-piezoelectric electroactive polymer actuator), an electromechanical actuator (such as a solenoid, voice coil, a brushed or brushless DC motor, or an AC induction or synchronous motor), or any other suitable actuator detailed in in U.S. patent application Ser. No. 15/372,362. Actuator 308 is preferably configured to produce a force of at least 10 N. In a more preferred embodiment, actuator 308 is configured to produce a force of at least 25 N. Actuator 308 is preferably configured to produce a displacement of at least 0.5 mm. The upper surface of actuator 308 preferably comprises an elastic material with a high coefficient of friction in contact with the material of force transmission element 202, such as polydimethylsiloxane or other silicone-based or non-silicone-based elastomers.

In the preferred embodiment, as illustrated in FIG. 3, actuator 308 is configured as a variable mechanical impedance brake. Alternate embodiments are contemplated wherein actuator 308 comprises an active actuation element configured to apply a variable force to force transmission element 202, in addition to said variable impedance brake (in mechanical serial or parallel configurations), or instead of it. This alternate embodiment and other suitable embodiments are described in detail in U.S. patent application Ser. No. 15/372,362.

Actuator housing 192 (FIG. 1) comprises upper housing 316 coupled to lower housing 306. Actuator 308 is coupled to the upper face of lower housing 306. Traction membrane 314 is coupled to the lower face of upper housing 316. In actuator's 308 off state, actuator housing 192 (FIG. 1) is coupled to force transmission element 202 by means of lower lip 307 and upper lip 315, thus preventing direct contact between force transmission element 202 and actuator 308 or traction membrane 314. In actuator's 308 on state, force transmission element 202 is frictionally coupled to actuator 308 and traction membrane 314 by the orthogonal displacement of actuator 308. Actuator 308 can be configured for binary control—acting like a simple brake—or proportional control—allowing the application of multiple intermediate levels of force to force transmission element 202 between full on and full off.

Actuator housing 192 (FIG. 1) supports actuator 308 and traction membrane 314, applying a normal force during actuation to maintain contact between actuator 308, traction membrane 314, and force transmission element 202. Traction membrane 314 is preferably included in actuator assembly 300 to maximize the holding force between actuator 308 and force transmission element 202. In one embodiment, traction membrane 314 comprises a material similar to the upper surface of actuator 308. In another embodiment, traction membrane 314 comprises a ratchet-like mechanism, having teeth or other projections that mate with similar projections on the surface of force transmission element 202 to increase the effective coefficient of friction between the two surfaces. In an alternate embodiment, traction membrane 314 is replaced with a second actuator above force transmission element 202.

Preferably, the opening in actuator housing 192 (FIG. 1) formed by upper lip 315 and lower lip 307 has a width sufficient to allow for some angular play of force transmission element 202 as the user's finger ad- and abducts. Said angular play permits substantially unobstructed ad- and abduction of the user's finger in free space. Actuator housing 192 (FIG. 1) is coupled to mechanical ground by means of mechanical ground connection 304.

Referring now to FIG. 1, a single finger exoskeleton assembly 107 is shown coupled to the user's thumb. In an alternate embodiment, a second finger exoskeleton assembly is additionally coupled to the thumb to control motion of the metacarpal.

### Mechanical Ground Connection

Reaction forces from the action of actuator 308 must be transferred to mechanical ground to produce a net force on the user's finger. In the embodiment of FIG. 1A, mechanical ground comprises the user's palm and wrist. Reaction forces from the action of actuator 308 are transferred to opisthenar plate 111 by means of mechanical ground connection 304, and in turn into the user's palm and wrist by means of fabric substrate 115 and wrist strap 116, among other elements. Said armature preferably distributes reaction forces generated by actuator 308 across the skin surface of the user's hand and arm as evenly as possible to minimize anomalous point forces.

In an alternate embodiment, reaction forces from the action of actuator 308 are transferred to an external mechanical structure, such as an arm exoskeleton, preferably by means of a temporary coupling point. Several related embodiments are presented in U.S. patent application Ser. No. 15/372,362.

### Tensioning Mechanism

FIG. 1A shows a preferred embodiment of a finger exoskeleton assembly 107, comprising a tensioning mechanism 143. Said tensioning mechanism is coupled to force transmission element 202, and serves to keep it under a nominal amount of tension during the operation of finger exoskeleton assembly 107. In the absence of a tensioning element, there is a risk of slack developing in force transmission element 202 distal to actuator assembly 300. Any such slack will produce an undesirable delay between the onset of actuation and the application of forces to the user's finger.

Tensioning mechanism 143 comprises an elastic band 142, preferably composed of natural latex or another suitable elastomer, coupled to force transmission element 202 by means of through-hole 146. The proximal end of elastic band 142 is coupled to hook 148, which is in turn coupled to termination block 140. Termination block 140 is coupled to opisthenar plate 111, and in turn to the user's hand by means of fabric substrate 115 and wrist strap 116, among other elements.

In a preferred embodiment, tensioning mechanism 143, or a separate tensioning mechanism, are additionally coupled to interface laminate ribbon assembly 207 to minimize slack in said ribbon assembly 207. Unlike force transmission element 202, slack in interface laminate ribbon assembly 207 won't compromise the function of interface laminate segment 204; however, slack in ribbon assembly 207 is undesirable as it will cause ribbon assembly 207 to protrude unnecessarily above the user's fingers during flexion. This protrusion increases the profile of a haptic feedback glove and introduces a risk of the user's fingers becoming tangled in ribbon assembly 207.

In an alternate embodiment, the tensioning mechanism 143 comprises an actuator of any of the types contemplated above or in U.S. patent application Ser. No. 15/372,362, which actively controls the tension of force transmission element 202. Said actuator can also be used to actuate finger exoskeleton assembly 107, as described above.

### Sensors

FIG. 8 shows a block diagram of a haptic feedback glove, in accordance with one embodiment. A haptic feedback glove preferably comprises a position sensor 832 configured to transduce the position or angle 822 of a digit of the user's hand, and a position sensor 832 configured to transduce the position or angle 820 of the palm of the user's hand. Many position sensors 832 suitable for capturing hand motion are described in U.S. patent application Ser. No. 15/372,362.

A haptic feedback glove can also comprise one or more force sensors 830 configured to transduce a point force 824 on the user's skin, or a net force/torque 826 on a digit of the user's hand to enable closed loop force control. Many suitable force sensors 830 are described in U.S. patent application Ser. No. 15/372,362.

In a preferred embodiment, shown in FIG. 1A, a magnetic position sensor 135 on the fingertip, and a magnetic position sensor (not shown) on the palm are used to transduce hand position. In an alternate embodiment, the magnetic sensor on the palm is replaced with an optical sensor. In a second alternate embodiment, wherein the haptic feedback glove is coupled to an arm exoskeleton, the magnetic sensor on the palm is obviated by position information supplied by the arm exoskeleton. In one variation, a first palm sensor is placed between the second and third metacarpals, and a second palm sensor is placed between the fourth and fifth metacarpals to transduce motion of the carpometacarpal joints of the pinky and/or ring finger.

In a preferred embodiment, a magnetic emitter (not shown) coupled to the user's hand emits a magnetic field. The strength of the magnetic field is employed by magnetic position sensor 135 to transduce its position relative to the emitter. Such magnetic emitters are well known in the art. In an alternate embodiment, said emitter is located off the user's body.

In one embodiment, biosignal sensors are included in the haptic feedback glove, as described in U.S. patent application Ser. No. 15/372,362.

### Veneer and Undersuit

In a preferred embodiment, a veneer layer (not shown) is included over a haptic feedback glove. In one embodiment, this veneer layer simply comprises a thin fabric glove. In another embodiment, the veneer layer includes rigid elements, particularly on the dorsal surface of the hand. The veneer layer serves to protect the functional components of a haptic feedback glove during operation and enhance the aesthetic appeal of the haptic feedback glove.

In a preferred embodiment, an undersuit glove is donned by the user before donning a haptic feedback glove. Said undersuit glove prevents direct skin contact between the user and the inside of the haptic feedback glove. The use of an undersuit glove reduces the need to clean the haptic feedback glove, and offers improved hygiene, particularly in cases where a single haptic feedback glove is shared between multiple users. Said undersuit is described in greater detail in U.S. patent application Ser. No. 15/372,362.

While the invention herein disclosed has been described by means of specific embodiments, examples and applications thereof, numerous modifications and variations could be made thereto by those skilled in the art without departing from the scope of the invention set forth in the claims.

1. A human-computer interface system including:
a sensor configured to transduce the location of a finger of a hand of a user;
an exoskeleton configured to exchange mechanical energy with the finger; and
an interface garment, including:
an interface laminate coupled to a counterpressure assembly, configured to stimulate the user by applying a pressure to the finger;
a first plurality of tactile actuators configured to apply a pressure to a finger of the user; and
a second plurality of tactile actuators configured to apply a pressure to a palm of the hand of the user.

2. The human-computer interface system of claim 1 wherein the sensor comprises at least one of: a magnetic sensor and an optical sensor.

3. The human-computer interface system of claim 2 further comprising a magnetic emitter coupled to the hand of the user.

4. The human-computer interface system of claim 1 wherein the interface laminate comprises a portion with at least 1 tactile actuator per square centimeter.

5. The human-computer interface system of claim 1 wherein the interface laminate comprises a tactile actuator with a displacement of at least 1 mm.

6. The human-computer interface system of claim 1 further comprising an intermediate layer between the interface laminate and skin of the user.

7. The human-computer interface system of claim 1 wherein the interface laminate is coupled to a vibration actuator.

8. The human-computer interface system of claim 7 wherein the vibration actuator comprises one of a piezoelectric actuator and a fluidic actuator.

9. The human-computer interface system of claim 1 wherein the counterpressure assembly comprises an armature and a tensile member.

10. The human-computer interface system of claim 9 wherein said tensile member comprises an elastic element.

11. The human-computer interface system of claim 9 wherein said armature contacts palmar and dorsal faces of a distal phalange of the finger, but does not contact medial and lateral faces of said finger.

12. The human-computer interface system of claim 1 wherein the interface garment comprises a palm assembly, including at least one of: a thenar assembly, a hypothenar assembly, and an interdigital assembly.

13. The human-computer interface system of claim 12 wherein the stiffness of said palm assembly varies between a first and second point along its surface.

14. The human-computer interface system of claim 13 having a less stiff portion adjacent to at least one of: a palmar interdigital crease, a transverse crease, and a thenar crease.

15. The human-computer interface system of claim 12 wherein the thenar assembly comprises a portion having a radius of curvature between 10 mm and 20 mm.

16. The human-computer interface system of claim 12 wherein the interdigital assembly comprises a portion having a radius of curvature between 56 mm and 94 mm.

17. The human-computer interface system of claim 1 wherein the interface garment comprises a wrist strap.

18. The human-computer interface system of claim 1 wherein the counterpressure assembly comprises a fastener configured to adjust pressure applied by the counterpressure assembly to a portion of the hand of the user.

19. The human-computer interface system of claim 1 comprising at least one of: an opisthenar plate, and a thenar plate.
